(19) United States
(12) Patent Application Publication
(10) Pub. No.: US 2017/0014011 A1
(43) Pub. Date: Jan. 19, 2017

(54) TELESCOPIC VACUUM EXTENSION MEMBER

(71) Applicant: Travis Robbins, Kimberly, ID (US)

(72) Inventor: Travis Robbins, Kimberly, ID (US)

(21) Appl. No.: 14/803,085

(22) Filed: Jul. 19, 2015

(51) Int. Cl. A47L 9/24; F16L 9/22

(52) U.S. Cl. CPC A47L 9/244; F16L 9/22

(57) ABSTRACT

A telescopic vacuum extension member for providing a vacuum attachment having a selectable length is defined by a plurality of extension sections integrated telescopically and selectively positionable in a nested position and an extended position. Each extension section defines a hollow, conical body and includes a frictional surface and/or a flange to enable it to, when placed in either the nested position or extended position, provide seals at the top and bottom of the telescopic vacuum extension member. The frictional surfaces is operative to provide a lower seal on one hand, and an interior seal on the other and defines a raised, deformable surface which extends around the extension section adjacent to the extension section's lower rim. The flange is operative to provide a top seal and defines a deformable flap which extends around the circumference of the extension section adjacent to the extension section's upper rim.

### BACKGROUND OF THE INVENTION

Field of the Invention

This invention relates generally to detachable extension nozzles and, more particularly, to a telescopically extendable, detachable extension member for a vacuum cleaner.

Description of the Prior Art

The use of conventional vacuum cleaners, typically defined by devices which employ a centrifugal fan to create a partial vacuum to suck up dust and debris, to clean areas in a home or for industrial cleaning is well known. Many vacuum cleaners come with and/or are used with specialized attachments to allow them to clean areas which may be otherwise inaccessible or out of reach, such as in crevices or elevated surfaces. One such attachment that is common is an extension wand, which typically defines an elongated hollow member what attaches to a suction source on the vacuum at one end, with its opposing end being manually extended towards a targeted inaccessible or unreachable location. A problem which still exists, however, is that conventional extension wands are often of a fixed length and cannot be adjusted to more easily reach either closer or more distant areas as desired. Thus, there remains a need for a telescopic vacuum extension member which would allow a user to selectively increase and decrease its length depending on the targeted area to be cleaned. It would be helpful if such a telescopic vacuum extension member employed a plurality of discrete extension sections nested together such that they could each be selectively positioned in a nested and extended position. It would be additionally desirable for such a telescopic vacuum extension member to employ extension sections having raised frictional contacts on their internal and/or external rim surfaces so as to allow them to be fixed in the nested or extended position while still maintaining a sufficient airtight seal to not hinder the desired sucking action of the vacuum cleaner.

The Applicant's invention described herein provides for a telescopic vacuum extension member adapted to allow a user to employ an extension attachment that could be selectively increased and decreased in size. The primary components in Applicant's telescopic vacuum extension member are a plurality of nested extension sections, each having a circumferential frictional surface disposed around their lower rim and/or a circumferential flange disposed around the their upper end. When in operation, the telescopic vacuum extension member enables more effective cleaning of hard to reach areas with conventional vacuum cleaners. As a result, many of the limitations imposed by prior art structures are removed.

### SUMMARY OF THE INVENTION

A telescopic vacuum extension member for providing a vacuum attachment having a selectable length. The telescopic vacuum extension member is defined by a plurality of extension sections integrated telescopically so as to be selectively positionable in a nested position and an extended position. Each extension section defines a hollow, conical body and includes a frictional surface, a flange, or both to enable it to, when placed in either the nested position or extended position, provide seals at the top and bottom of the telescopic vacuum extension member. The frictional surfaces, which define a raised, deformable surface which extends around the extension section adjacent to the extension section's lower rim are operative to provide a lower seal on one hand, and an interior seal on the other. The flange, which defines a deformable flap which extends around the circumference of the extension section adjacent to the extension section's upper rim, is operative to provide a top seal.

It is an object of this invention to provide a telescopic vacuum extension member which would allow a user to selectively increase and decrease its length depending on the targeted area to be cleaned.

It is another object of this invention to provide a telescopic vacuum extension member that employs a plurality of discrete extension sections nested together such that they could each be selectively positioned in a nested and extended position.

It is yet another object of this invention to provide a telescopic vacuum extension member which employs extension sections having raised frictional contacts on their internal and/or external rim surfaces so as to allow them to be fixed in the nested or extended position while still maintaining a sufficient airtight seal to not hinder the desired sucking action of the vacuum cleaner.

These and other objects will be apparent to one of skill in the art.

### BRIEF DESCRIPTION OF THE DRAWINGS

FIG. 1 is a side elevational view of a telescopic vacuum extension member built in accordance with the present invention with each of its extension section in a nested position.

FIG. 2 is a side elevational view of a cross section of a telescopic vacuum extension member built in accordance with the present invention with each of its extension section in a nested position.

FIG. 3 is a side elevational view of a cross section of a telescopic vacuum extension member built in accordance with the present invention with each of its extension section in an extended position.

FIG. 4 is a bottom plan view of a telescopic vacuum extension member built in accordance with the present invention with each of its extension section in a nested position.

FIG. 5 is a side elevational view of a cross section of an extension section of a telescopic vacuum extension member built in accordance with the present invention.

### DETAILED DESCRIPTION OF THE INVENTION

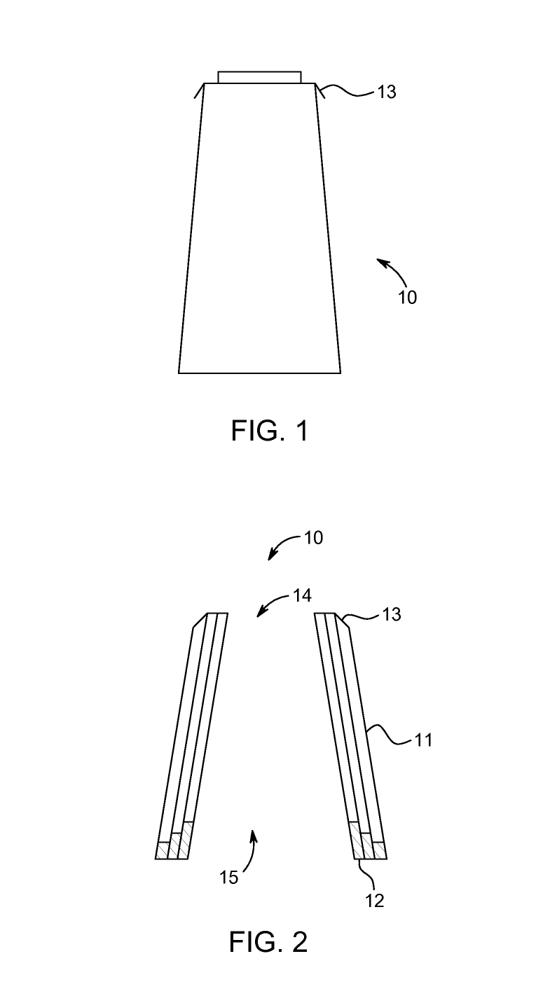

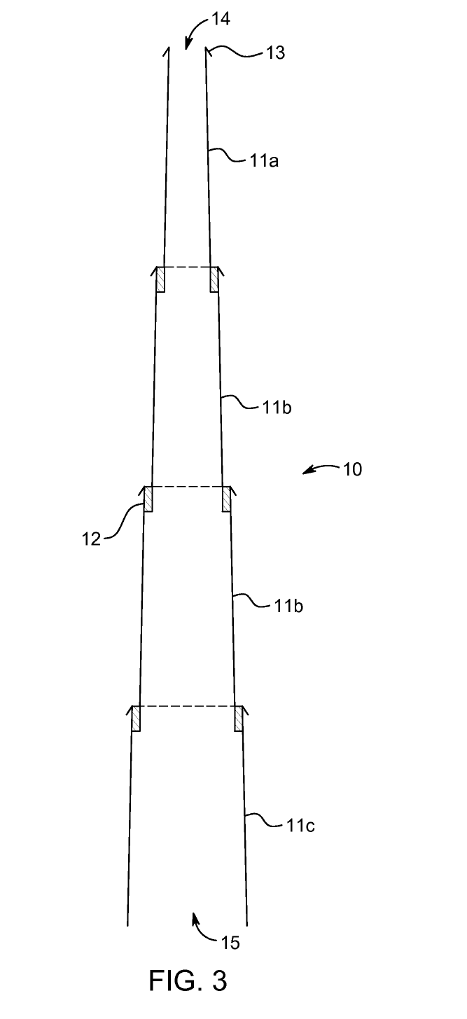

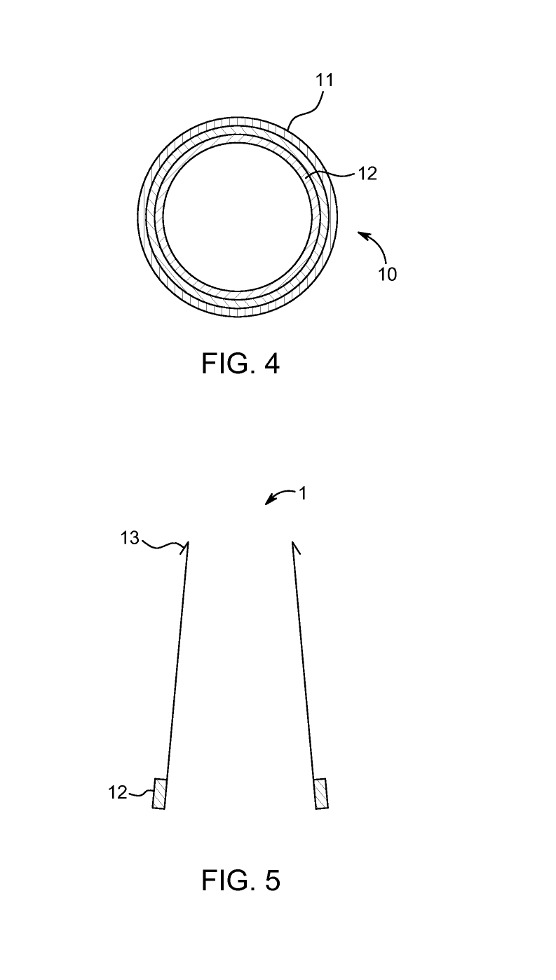

Referring now to the drawings and in particular FIGS. 1, 2, 3, and 4, a telescopic vacuum extension member 10 is shown having a plurality of extension sections 11 integrated telescopically so as to be selectively positionable in both a nested position, as illustrated in FIGS. 1 and 2, and an extended position, as illustrated in FIG. 3. Each extension section 11 defines a hollow, conical body that includes a frictional surface 12 and/or a flange 13. The frictional surface 12 defines a raised, deformable surface which extends around the extension section 11 adjacent to the extension section's 11 lower rim. The flange 13 defines a deformable flap which extends around the circumference of the extension section 11 adjacent to the extension section's 11 upper rim.

It is contemplated that each extension section 11 is separately movable between and fixable in a position where it extends from and/or is nested in the extension section 11 adjacent thereto.

In the preferred embodiment, the plurality of extension sections 11 define a tip section 11a, a two middle sections 11b, and a base section 11c. In this embodiment, the tip section 11a includes both a frictional surface 12 and a flange 13, the two middle sections 11b include both a frictional surface 12 and a flange 13, and the base section 11c includes just a flange 13.

Accordingly, in the preferred embodiment, when the telescopic vacuum extension member 10 is positioned in its nested position, the flanges 13 on the tip section 11a and the two middle sections 11b, respectively, contact the top of the extension section 11 immediately outside thereof so as to form a top seal for the telescopic vacuum extension member 10. Similarly, the frictional surface 12 of the tip section 11a and the two middle sections 11b, respectively, contact the inner surface at the bottom of the extension section 11 immediately inside thereof so as to form a bottom seal for the telescopic vacuum extension member 10, as illustrated in FIG. 2.

When the telescopic vacuum extension member 10 is positioned in its extended position, the frictional surface 12 of the tip section 11a and the two middle sections 11b, respectively, contact the inner surface at the bottom of the extension section 11 immediately inside thereof so as to form an interior seal for the telescopic vacuum extension member 10, as illustrated in FIG. 3.

In one embodiment, the tip section 11a and the two middle sections 11b measure 3 feet, 3 inches long, the base section 11c measures 3 inches, the top opening 14 of the tip section 11a has a 1¼ inch diameter, and the bottom opening 15 of the base section 11c has a 2¼ inch diameter. In this regard, the bottom opening 15 of the is suited to connect to a conventional vacuum cleaner and the top opening 14 is suitable for directing towards a target area to be cleaned.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A telescopic vacuum extension member, comprising:
a plurality of telescopically integrated extension sections, each defining a hollow, conical body having a lower rim and an upper rim and including at least one of a frictional surface adjacent to the lower rim and a flange extending from the upper rim;
said extension sections sized to enable each extension section to be positioned in a nested configuration so as to be selectively positionable in both a nested position and an extended position; and
said extension sections together configured by way of the respective frictional surfaces and flanges to form a single interior channel whether positioned in the nested position or extended position.

2. The telescopic vacuum extension member of claim 1, wherein said plurality of extension sections define a tip section, at least one middle sections, and a base section.

3. The telescopic vacuum extension member of claim 2, wherein the tip section and at least one middle sections each include a frictional surface and a flange.

4. The telescopic vacuum extension member of claim 3, wherein the base section includes a flange.

5. The telescopic vacuum extension member of claim 2, wherein said plurality of extension sections define a tip section, a plurality of middle sections, and a base section.
